(19) United States
(12) Patent Application Publication
(10) Pub. No.: US 2019/0001293 A1
(43) Pub. Date: Jan. 3, 2019

(54) AEROGELS, MATERIALS USING SAME, AND METHODS FOR PRODUCING SAME

(71) Applicant: Panasonic Intellectual Property Management Co., Ltd., Osaka (JP)

(72) Inventors: KAZUMA OIKAWA, Osaka (JP); KEI TOYOTA, Osaka (JP); TAICHI NAKAMURA, Osaka (JP); SHIGEAKI SAKATANI, Osaka (JP)

(21) Appl. No.: 15/735,887

(22) PCT Filed: Jun. 24, 2016
(86) PCT No.: PCT/JP2016/003051

§ 371 Date: Dec. 12, 2017

(30) Foreign Application Priority Data
Jul. 1, 2015 (JP) 2015-132279

(51) Int. Cl. B01J 13/00; B01J 20/22; B01J 20/28; B01J 20/30; F16L 59/02; G10K 11/162

(52) U.S. Cl. CPC B01J 13/0091; B01J 20/22; G10K 11/162; B01J 20/3085; F16L 59/028; B01J 20/28047

(57) ABSTRACT

Disclosed is an aerogel, having, on the surface of the aerogel, at least one type of dialkyldisiloxane bond serving as a hydrophobic group, and/or at least one type of crosslinked disiloxane bond serving as a hydrophobic group. Further disclosed is a material serving as at least one material selected from among a heat-insulation material, a sound-absorbing material, a water-repellant material, and an adsorption material, and this material includes the above-mentioned aerogel. Yet further disclosed is a method for producing the above-mentioned aerogel.

### TECHNICAL FIELD

The technical field relates to aerogels, materials using the same, and methods for producing the same. In particular, the technical field relates to hydrophobic aerogels, materials using the same, and methods for producing the same.

### BACKGROUND

Currently, high-performance heat-insulation materials have been required in view of environments. With regard to urethane forms (polyurethane; PU), and expanded polystyrene (EPS), which have been employed as general-purpose heat-insulation materials, or vacuum insulated panels (VIPs), their heat-insulation performance deteriorates with age, and their heat resistance is low.

Meanwhile, silica aerogels have been employed as heat-insulation materials. Silica aerogels have high heat resistance; they are resistant to a high-temperature environment at 400° C. or higher. Therefore, silica aerogels have attracted a great deal of attention as next-generation heat-insulation materials.

Aerogels are produced through sol-gel reactions in which water glass (aqueous sodium silicate solutions), and alkoxysilanes such as tetramethoxysilane (TEOS) are employed as starting materials.

At first, the materials, and liquid media such as water or alcohols are mixed to hydrolyze the materials. Then, the materials are polycondensed in the liquid media, and thus, hydrogels (i.e., gels containing water) are formed. This step is called aging. The aging step progresses the above polycondensation reaction, and thus, reinforces networks of silica particles in the hydrogels through formation of large-boned networks thereof.

Subsequently, the hydrogels are subjected to a hydrophobization reaction. Optionally, the solvent may be substituted prior to the hydrophobization reaction. If any hydrophobization treatments are not carried out, shrinkage of the gel skeletons would occur due to generation of strong capillary force when the liquid media are evaporated in the drying step, and, consequently, silica particles would be brought into physical contact with each other. As a result, dehydration/condensation reactions among silanols present on their surfaces would proceed, and this would provoke the shrinkage and high densification. Therefore, omission of the hydrophobization treatments is unpreferable.

On the other hand, when silanols present on surfaces of silica particles sufficiently react with silylation agents through hydrophobization reactions, and thus, hydroxyl groups are capped (i.e., termini of the silanols are attached with the silylation agents), the shrinkage will significantly be alleviated, and thus, the shrinkage/high densification will be suppressed, even if the gel skeletons are temporarily shrunk due to the capillary force generated during the evaporation of the liquid media in the gels for the purpose of drying the gels, since no silanols exist therein anymore.

The above phenomenon is called “springback.” Thus, the above-mentioned hydrophobization is essential in order to cause the spring back.

As examples of hydrophobization agents, compounds having structures represented by general formula Rₙ—Si—X₄₋ₙ, and silazanes shown as general formula R₃Si—NH—SiR₃ can be mentioned. In particular, with regard to hydrophobization agents that would preferably be used for the hydrophobization treatments, methods specifically using trimethylchlorosilane, dimethyldichlorosilane, monomethyltrichlorosilane, and hexamethyldisilazane have been known (JP-A-2012-172378).

Furthermore, a method for producing an aerogel characterized by use of a disiloxane represented by general formula R₃Si—O—SiR₃, or a disilazane represented by general formula R₃Si—N(H)—SiR₃ has been known (JP-T-2001-524439).

Finally, the liquid media inside the hydrogels are evaporated to dry the hydrogel. For the drying technique, supercritical drying methods, and non-supercritical drying methods (ordinary-pressure drying methods, and freeze-drying methods) are available.

### SUMMARY

An object of the disclosure is to provide hydrophobic aerogels that have high thermostability and that hardly react with water present in the atmosphere, materials using the same, and methods for producing the same.

According to a first aspect of the disclosure, provided is an aerogel, having, on the surface of the aerogel, at least one type of dialkyldisiloxane bond serving as a hydrophobic group, and/or at least one type of crosslinked disiloxane bond serving as a hydrophobic group.

In some embodiments, the alkyl groups present in the at least one type of dialkyldisiloxane bond each have a carbon number from 1 to 10.

In some embodiments, the above aerogel further has on the surface of the aerogel at least one type of trialkylsiloxane bond, and the number of molecules of the at least one type of dialkyldisiloxane bond and/or the at least one type of crosslinked disiloxane bond may be about 0.5 to about 1.5 times greater than the number of molecules of the at least one type of trialkylsiloxane bond. In that case, the alkyl groups present in the at least one type of trialkylsiloxane bond may each have a carbon number from 1 to 10.

In some embodiments, the above aerogel further has, on the surface of the aerogel, both of the at least one type of dialkyldisiloxane bond and the at least one type of crosslinked disiloxane bond.

Moreover, according to a second aspect of the disclosure, provided is an aerogel, further including: a first aerogel having, on the surface of the first aerogel, at least one type of dialkyldisiloxane bond serving as a hydrophobic group, and/or at least one type of crosslinked disiloxane bond serving as a hydrophobic group; and a second aerogel having on the surface of the second aerogel at least one type of trialkylsiloxane serving as a hydrophobic group, wherein the number of molecules of the at least one type of dialkyldisiloxane bond and/or the at least one type of crosslinked disiloxane bond is about 0.5 to about 1.5 times greater than the number of molecules of the at least one type of trialkylsiloxane bond. In this case, the alkyl groups present in the at least one type of trialkylsiloxane bond may each have a carbon number from 1 to 10.

In some embodiments, the above-described aerogels have a mean pore diameter from about 10 nm to about 60 nm, a pore volume from about 3.0 cc/g to about 10 cc/g, and a specific surface area from about 200 m²/g to about 1200 m²/g.

Furthermore, according to a third aspect of the disclosure, provided is a material serving as at least one material selected from among a heat-insulation material, a sound-absorbing material, a water-repellant material, and an adsorption material, said material comprising the aerogel according to the first or second aspect of the disclosure.

Additionally, provided is a method for producing an aerogel, including: (i) providing a silica hydrogel; and (ii) hydrophobizing the silica hydrogel by using at least one siloxane selected from among a chain siloxane represented by Formula (1), and a cyclosiloxane represented by Formula (2):

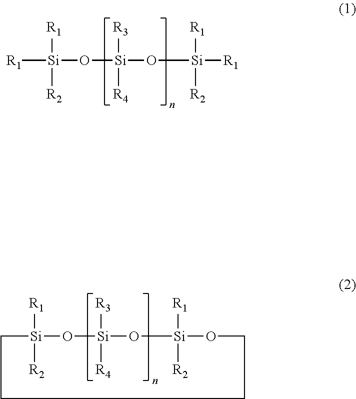

wherein 1≤n≤3, and R₁ to R₄ independently represent C1-C10 aliphatic hydrocarbon groups.

In some embodiments, instep (ii), the silica hydrogel is soaked in 3-12 N hydrochloric acid to cause said hydrochloric acid to penetrate into the silica hydrogel, and the silica hydrogel is hydrophobized in a mixture solvent of an alcohol and the at least one siloxane.

Detailed description on specific embodiments and examples of the disclosure will further be provided below.

Aerogels according to the disclosure have dialkyldisiloxane bonds that are hardly thermally decomposed compared with trialkylsiloxane bonds. Therefore, the aerogels have improved thermostability, and produce reduced amounts of low-molecular siloxanes, compared with conventional aerogels.

Furthermore, hydrophobization agents used in the disclosure have higher boiling points, and will never be hydrolyzed through reactions with water present in the atmosphere. Therefore, it becomes possible to produce the aerogels according to the disclosure on an industrial scale. The aerogels can be employed to provide excellent heat-insulation materials, sound-absorbing materials, water-repellant materials, adsorption material, and the like.

### BRIEF DESCRIPTION OF THE DRAWINGS

FIG. 1 is a diagram that shows a dialkyldisiloxane bond of an aerogel according to an embodiment.

FIG. 2 is a diagram that shows a trialkylsiloxane bond of a conventional aerogel.

FIG. 3 is a diagram that shows a trialkylsilanol produced from a conventional aerogel.

FIG. 4 is a diagram that shows a method for producing an aerogel according to an embodiment.

FIG. 5 is a diagram that shows a chain siloxane that serves as a hydrophobization agent in an embodiment.

FIG. 6 is a diagram that shows a cyclosiloxane that serves as a hydrophobization agent in an embodiment.

FIG. 7 is a diagram that shows a mechanism for a reaction between a chain siloxane and hydrochloric acid in an embodiment.

FIG. 8 is a diagram that shows a mechanism for a reaction between a cyclosiloxane and hydrochloric acid in an embodiment.

FIG. 9 is a diagram that shows formation of a trialkylsiloxane bond in a conventional embodiment.

FIG. 10 is a diagram that shows formation of a dialkyldisiloxane bond in an embodiment.

FIG. 11 is a diagram that shows formation of a crosslinked disiloxane bond in an embodiment.

### DESCRIPTION OF EMBODIMENTS

Prior to descriptions of the present embodiments, problems in conventional arts will briefly be mentioned. In the above-mentioned conventional arts, the hydrogels are hydrolyzed by use of chloromethylsilane, hexamethyldisiloxane, or hexamethyldisilazane that serves as a hydrophobization agent. In this case, only trimethylsilyl groups (trialkylsiloxane bonds), which behave as hydrophobic groups, exist on surfaces of aerogels. Therefore, the gels have lower thermostability, and low-molecular siloxanes such as trimethylsilanol are produced due to thermal decomposition.

Furthermore, the hydrophobization agents have lower boiling points, and thus, are easily hydrolyzed through reactions with water present in the atmosphere. For this reason, a problem will arise in cases where the aerogels are produced on an industrial scale.

Hereinafter, the disclosure will be described with reference to one preferable embodiment.

### <Aerogel 111a Having a Dialkyldisiloxane Bond 110>

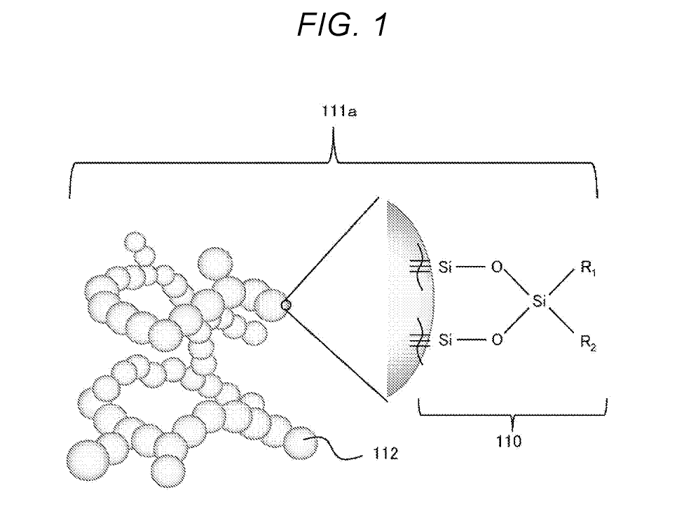

FIG. 1 shows a structure of an aerogel 111a according to an embodiment. That is, FIG. 1 shows a network structure in the aerogel 111a having a dialkyldisiloxane bond 110. With regard to production of the aerogel 111a, water glass, or an alkoxysilane is used as a starting material. Through hydrolysis and dehydration/condensation of the material, a hydrophilic dehydration/condensation product (hydrogel) that includes SiO₂ particles 112 is obtained. The aerogel 111a according to this embodiment can be obtained by hydrophobizing the hydrogel. Thus, the aerogel 111a according to this embodiment is a hydrophobic aerogel having at least one type of a dialkyldisiloxane bond 110.

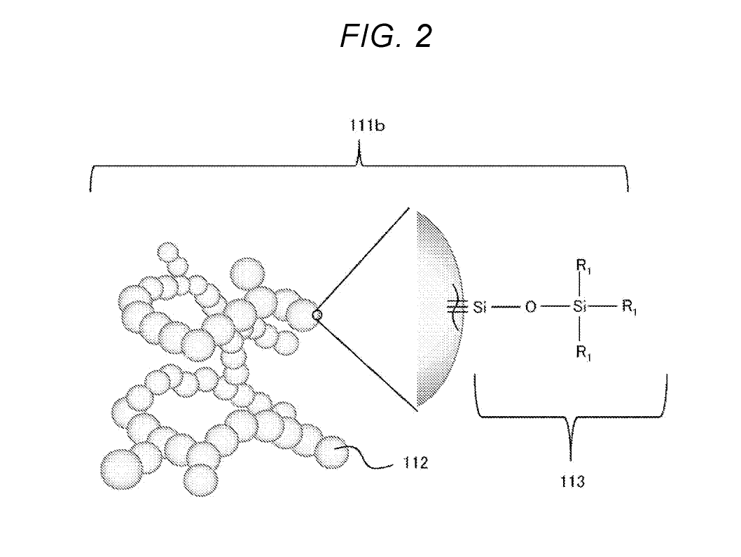

FIG. 2 schematically shows a network structure of a conventional aerogel 111b having a trialkylsiloxane bond 113. As shown in FIG. 2, the aerogel 111b that is obtained based on the conventional hydrophobization technique has only such a trialkylsiloxane bond 113. Therefore, the aerogel 111b has inferior thermostability, as compared with the aerogel 111a according to the embodiment, which has the at least one type of dialkyldisiloxane bond 110, as shown in FIG. 1.

Thermal decomposition of the siloxane bonds occurs due to rapture of Si—O bonds. A bonding energy of the Si—O bond in the conventional trialkylsiloxane bond 113 is 444 kJ/mol. On the other hand, a bonding energy of the Si—O bond in the dialkyldisiloxane bond 110 in this embodiment is twice as large as the bonding energy in the conventional trialkylsiloxane bond 113, and thus, is 888 kJ/mol.

Accordingly, the aerogel 111a having such a dialkyldisiloxane bond 110 according to this embodiment has improved thermostability.

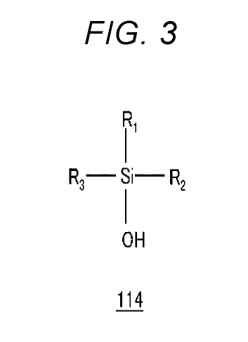

FIG. 3 refers to a trialkylsilanol 114 that is produced from the conventional aerogel 111b due to thermal decomposition of siloxane bonds. If aerogels have improved thermostability, siloxane bonds will not be decomposed. Therefore, in that case, it becomes possible to reduce generation of the trialkylsilanol 114.

Production of low-molecular siloxanes including such a trialkylsilanol 114 induces defects inside electronic devices, and therefore, is unpreferable. As one example of a defect caused due to production of siloxanes in electronic devices, a defect in relay contacts would frequently be caused. If silicone, which would produce low-molecular siloxanes, is used inside sealed components, due to heat generated through operation of the components, siloxanes would be produced from silicone, and the produced siloxanes adhere onto the relay contact points. In particular, relay contact points in which frequencies of on/off action are high are constantly impacted. Consequently, siloxanes that have adhered onto the contact points will be decomposed through oxidation, and SiO₂ will be produced therein. As a result, the produced SiO₂ acts as an electrical insulant, and interferes with the contact points. In addition, in FIGS. 1-3, R₁ to R₃ are independent from one another, and may be the same or different from each other.

### <Physical Properties of the Aerogel 111a According to the Embodiment>

The aerogel 111a according to the embodiment may have a mean pore diameter of about 10 nm to about 60 nm, a pore volume of about 3.0 cc/g to about 10 cc/g, and a specific surface area of about 200 m²/g to about 1200 m²/g.

The mean pore diameter may preferably be from about 10 nm to about 60 nm, more preferably from about 20 nm to about 50 nm. If the mean pore diameter is smaller than 10 nm, then, amounts of solid components may become excessive, and therefore, the thermal conductivity may become larger due to influences of the solid heat-transmitting components.

Furthermore, if the mean pore diameter is larger than 60 nm, then, the mean pore diameter will be close to 68 nm, which is a mean free path of nitrogen molecules that occupies about 78% of the air. Consequently, the thermal conductivity may become larger.

In addition, a diameter (d) of nitrogen molecules is about 370 pm. Based on this value, the mean free path of nitrogen molecules at ordinary temperature (25° C.) and at ordinary pressure (1.0×10⁵ Pa) is calculated as 68 nm.

As long as the mean pore diameter is within a range from about 20 nm to about 50 nm, there would be little influences of the solid heat-transmitting components. Furthermore, since the mean pore diameter is sufficiently smaller than the mean free path of nitrogen molecules, a hydrophobic aerogel having a desirable thermal conductivity can be obtained.

The pore volume is preferably from about 3.0 cc/g to about 10 cc/g. If the pore volume is smaller than 3.0 cc/g, then, amounts of solid components would be excessive, and therefore, the thermal conductivity may become larger due to influences of the solid heat-transmitting components. If the pore volume is larger than 10 cc/g, amounts of solid components may excessively be small, and therefore, influences of gases (nitrogen molecules) may adversely be larger, thereby increasing the thermal conductively.

The specific surface area is preferably from about 200 m²/g to about 1200 m²/g. If the specific surface area is smaller than 200 m²/g, amounts of solid components may be excessive, and therefore, the thermal conductivity may be larger due to influences of the solid heat-transmitting components. On the other hand, if the specific surface area is larger than 1200 m²/g, amounts of solid components may excessively be small, and thus, influences of gases (nitrogen molecules) may adversely be larger, and thermal conductivity may be larger.

When the mean pore diameter and the pore volume of the aerogel 111a are within the above-described ranges, the aerogel 111a will have excellent heat-insulation properties, and therefore, will be suitable as a heat-insulation material or a sound-absorbing material. Furthermore, when the specific surface area of the aerogel 111a is within the above-described range, the aerogel 111a will be suitable as a water-repellant material, or an adsorption material.

The mean pore diameter and the pore volume of the aerogel 111a can easily be controlled by adjusting the silica concentration of the water glass or an alkoxysilane serving as a starting material, a type and a concentration of the acid or base used for production of the sol, conditions (temperature and time) for gelatinization of the sol, a type/amount of the hydrophobization agent, an amount of the solvent used for the hydrophobization, a temperature during hydrophobization, a period of time for the hydrophobization, etc.

<Method for Producing an Aerogel 111a>

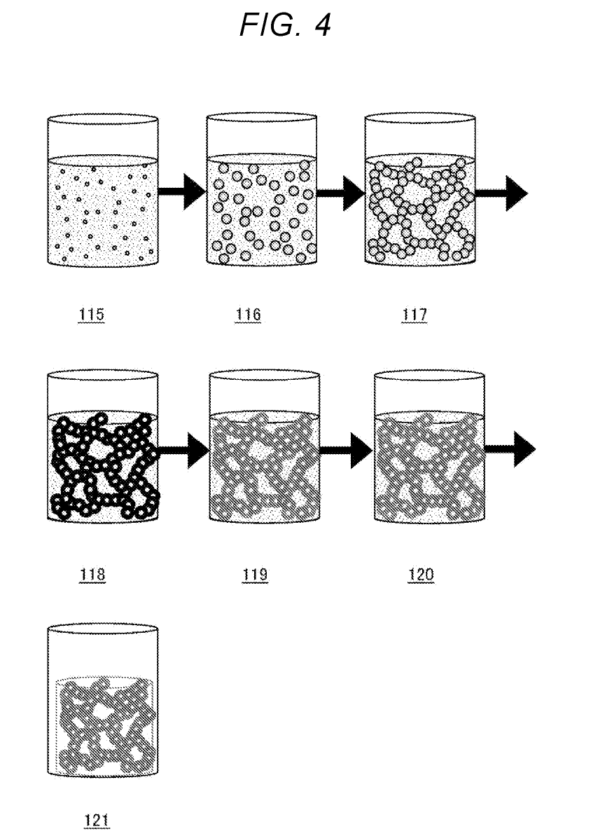

A method for producing an aerogel 111a according to an embodiment will be described below. FIG. 4 shows a method for producing a hydrophobic aerogel according to an embodiment. In addition, conditions described below are merely one example, and the disclosure is not limited to the conditions.

At first, water glass or an alkoxysilane serving as a starting material is prepared (provided) in a preparation step 115, and then, the prepared material is adjusted to a state that is ready for the gelatinization step, in the sol-preparation steps 116 and 117.

After the gelatinization step, the skeleton of the silica is reinforced in an aging step 118.

Then, a hydrophobization step (first and second steps 119 and 120) in which the surface of the aerogel is hydrophobized are carried out to prevent shrinkage of the gel during a drying step (described below).

Finally, a drying step 121 is carried out to remove the solvent, and thus, a hydrophobic aerogel is produced.

### <Sol-Preparation Steps 116 and 117>

In the sol-preparation step, a pH adjusting agent is added to water glass or an alkoxysilane serving as a starting material to cause polycondensation of the water glass or the alkoxysilane. In present embodiments, a silicate concentration of water glass or the alkoxysilane used as a starting material is preferably from about 4% to about 20%, more preferably from about 6% to about 16%.

If the silicate concentration is lower than 4%, then, the silicate concentration may be excessively low, and therefore, the strength of the skeleton of the resulting hydrogel may be insufficient.

On the other hand, if the silicate concentration exceeds 20%, then, amounts of solid components may be excessive, and therefore, thermal conductivity of the resulting aerogel may become excessively high. Furthermore, the time until gelatinization of the sol solution is completed may drastically be short, and therefore, it may become impossible to control the gelatinization time.

An acid catalyst is preferably added to the reaction solution in order to promote the polycondensation (hydrolysis).

When the silicate concentration is within a range from about 6% to about 16%, the gel will have sufficient strength of the skeleton so as to withstand capillary pressures generated during the drying step. Accordingly, the gel will not shrink or collapse during the drying step. Furthermore, the concentration of solid components would be within an appropriate range, and thus, the aerogel will not have excessively large thermal conductivity.

With regard to types of acid catalyst used herein, inorganic acids (e.g., hydrochloric acid, nitric acid, sulfuric acid, hydrofluoric acid, sulfurous acid, phosphoric acid, phosphorous acid, hypophosphorous acid, chloric acid, chlorous acid, and hypochlorous acid), acidic phosphates (e.g., acidic aluminum phosphate, acidic magnesium phosphate, acidic zinc phosphate), organic acids (e.g., acetic acid, propionic acid, oxalic acid, succinic acid, citric acid, malic acid, adipic acid, and azelaic acid), etc. can be mentioned. Although types of acid catalysts used herein are not limited, hydrochloric acid is preferable in terms of strength of the gel skeleton, and hydrophobicity of the resulting silica aerogel. Additionally, for the pH adjusting agent that is employed to promote the polycondensation (hydrolysis), bases that have generally been used therefore can be employed without any particular limitations. However, NH₄OH, NaOH, KOH, and/or Al(OH)₃ are preferably used therefore.

With regard to a concentration of the acid, for example, in a case of hydrochloric acid, the concentration may be preferably from 1 N to 12 N, more preferably from 6 N to 12 N. If the concentration is lower than 1 N, then, it may be required that a larger amount of such dilute hydrochloric acid added thereto to adjust the pH of the starting material aqueous solution. Therefore, the silicate concentration may be reduced, and thus, development of the silica network may not effectively be progressed.

With regard to an amount of the acid catalyst added to the reaction, in a case in which 12 N aqueous hydrochloric acid is used, about 0.5% to about 6.0% of the aqueous hydrochloric acid is preferably used relative to 100% by weight of the hydrogel. If the amount of the aqueous hydrochloric acid is smaller than 0.5%, or is larger than 6.0%, the high-molar-ratio silicate aqueous solution may not be gelatinized, although it depends on the temperature during the process.

The above-mentioned acid catalyst is added to the starting material aqueous solution to gelatinize the prepared sol solution. The gelatinization of the sol is preferably carried out inside a sealed vessel, such that the liquid solvent is not vaporized.

When the acid is added to the starting material aqueous solution to gelatinize it, the pH is preferably from about 4.0 to about 8.0. If the pH is smaller than 4.0, or is larger than 8.0, the high-molar-ratio silicate aqueous solution may not be gelatinized, although it depends on the temperature during the process.

A temperature for gelatinization of the sol (gelatinization temperature) is preferably from about 0° C. to about 100° C., more preferably from about 20° C. to about 90° C. in case where the gelatinization step is carried out under ordinary pressure.

If the gelatinization temperature is lower than 0° C., a required amount of heat will not be transmitted to the sol, and thus, growth of silica particles may not be promoted. As result, it may take a long time until the gelatinization is sufficiently progressed. Furthermore, the strength of the produced hydrogel may be lower, and therefore, the hydrogel may significantly be shrunk during the drying step. Additionally, in that case, a desirable silica aerogel may not be obtained.

Furthermore, if the gelatinization temperature exceeds 100° C., water may be vaporized inside the vessel that may even be sealed, and a phenomenon in which water and the gel are separated from each other. Consequently, a volume of the resulting hydrogel may be reduced, and a desirable silica aerogel may not be obtained.

### <Aging Step 118>

A temperature for the aging step (aging temperature) is preferably from about 0° C. to about 100° C., more preferably from about 60° C. to about 90° C., at ordinary pressure, although it depends on what types of materials are used herein.

If the aging temperature is lower than 0° C., a required amount of heat may not be transmitted to the silicate, in the same manner as the case of gelatinization, and thus, growth of silica particles may not be promoted. Therefore, it may take a long time until aging of the gel is sufficiently progressed. Furthermore, the resulting hydrogel may have lower strength, and thus, may be shrunk during the drying step. Consequently, a desirable silica aerogel may not be obtained.

Furthermore, if the aging temperature exceeds 100° C., water may be vaporized inside the vessel that may even be sealed, and a phenomenon in which water and the gel are separated from each other. Consequently, a volume of the resulting hydrogel may be reduced, and a desirable silica aerogel may not be obtained.

The aging time is preferably from 3 minutes to 24 hours although it depends on the aging temperature. If the aging time is shorter than 3 minutes, then, improvements in strength of the wall of the gel may be insufficient. If the aging time exceeds 24 hours, the aging step may not have much effect on improvements of the strength of the wall of the gel, and thus, the productivity may adversely be impaired.

In order to increase the pore volume or the mean pore diameter of the silica aerogel, the gelatinization temperature and/or the aging temperature may preferably be increased within the above-described ranges, or the total of the gelatinization time and the aging time may preferably be increased within the above-mentioned ranges.

Furthermore, in order to reduce the pore volume and the mean pore diameter of the silica aerogel, the gelatinization temperature and/or the aging temperature may preferably be decreased within the above-described ranges, or the total of the gelatinization time and the aging time may preferably be shortened within the above-mentioned ranges.

### <Hydrophobization Step (First Hydrophobization Step 119 and Second Hydrophobization Step 120)>

In the Hydrophobization step, the hydrophilic hydrogel is reacted with a hydrophobization agent to produce a hydrophobic gel. The hydrophobization step mainly includes the following two steps.

At first, in the first hydrophobization step 119, hydrochloric acid is incorporated into pores of the aged hydrogel. In this case, the concentration of hydrochloric acid is preferably from about 3 N to about 12 N.

If the concentration of hydrochloric acid is lower than 3 N, then, concentrations of active species that are reaction products of siloxanes may be lower because of such a lower concentration of hydrochloric acid, and thus, the second step (hydrophobization step 120) may not sufficiently proceed.

Hydrochloric acid with a concentration higher than 12 N has industrially been manufactured, and therefore, has not been available.

Furthermore, an amount of hydrochloric acid is not particularly limited as long as the amount makes it possible for the hydrogel to sufficiently be soaked in the hydrochloric acid. However, about 2 to about 100 times the amount of hydrochloric acid to a weight of the hydrogel is preferably employed.

If the amount of hydrochloric acid is smaller than the weight of the hydrogel, then, concentrations of active species that are reaction products of siloxanes may be lower because of such a lower concentration of hydrochloric acid, and thus, the second hydrophobization step 120 may not sufficiently proceed.

Furthermore, if the amount of hydrochloric acid exceeds the 100 times larger than the weight of the hydrogel, the productivity may be impaired because such an excess amount of hydrochloric acid is employed. With regard to conditions for soaking the hydrogel in hydrochloric acid, a temperature of the aqueous hydrochloric acid is preferably from about 0° C. to about 50° C., and the soaking time is preferably from about 30 seconds to about 72 hours.

If the temperature is lower than 0° C., and the soaking time is shorter than 30 seconds, then, hydrochloric acid may not sufficiently penetrate into pores of the hydrogel.

If the temperature is higher than 50° C., and the soaking time is longer than 72 hours, then, the productivity may be impaired.

In the second hydrophobization step 120, active species produced through a reaction between hydrochloric acid that has been caused to penetrate into pores of the hydrogel, and the hydrophobization agent are caused to react with silanols present on surfaces of silica particles.

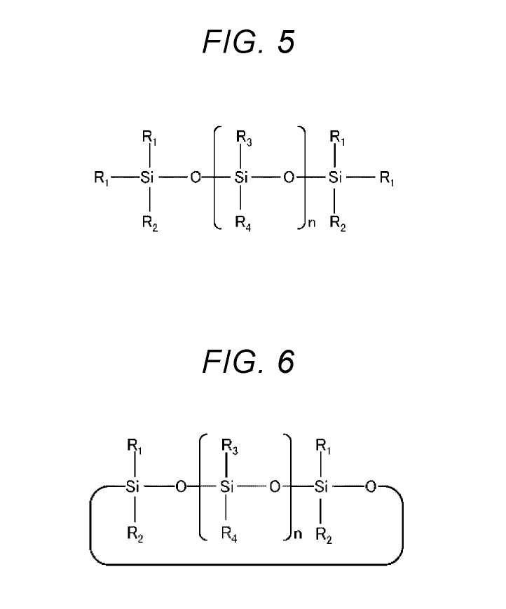

In this embodiment, the hydrophobization agent is a chain siloxane shown in FIG. 5, or a cyclosiloxane shown in FIG. 6. In FIG. 5, n=1 to 3, and R₁ to R₄ are independent from one another, and may the same or different from one another. R₁ to R₄ are C1-C10 aliphatic hydrocarbon groups, and may be linear, branched or cyclic groups. For commercial reasons, it would be difficult to obtain aliphatic hydrocarbon groups having carbon numbers of less than 1, or carbon numbers of 11 or more.

In view of steric structures, R₁ and R₂ may preferably be the same. Furthermore, R₃ and R₄ may preferably be the same.

In this embodiment, the above-described hydrophobization agent is used as at least one hydrophobization agent. Furthermore, the hydrogel is soaked in hydrochloric acid prior to use of the above-described hydrophobization agent, and then, the hydrophobization reaction is carried out in a mixture solvent of an alcohol and the above hydrophobization agent.

### <Mechanism for Reactions Involved in the Hydrophobization Steps 119 and 120>

Hereinafter, a reaction mechanism of hydrophobization in present embodiments will be described.

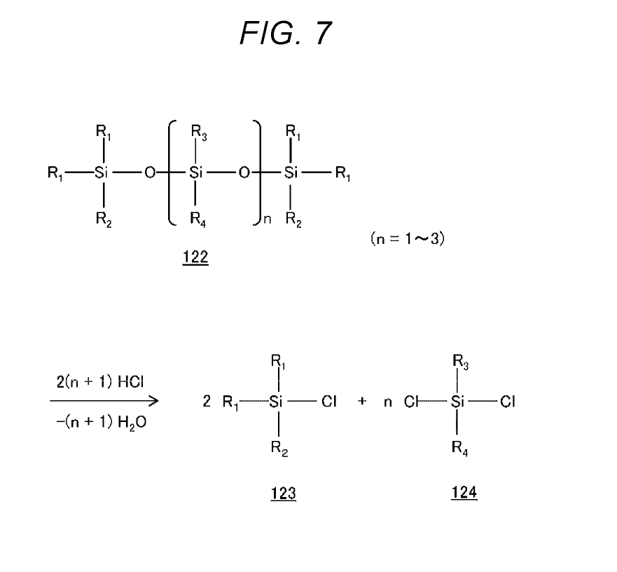

FIG. 7 shows that a trialkylchlorosilane 123, and a dialkyldichlorosilane 124 are produced through a reaction between a chain siloxane 122 (serving as a hydrophobization agent) and hydrochloric acid in the embodiment. By causing the chain siloxane 122 and hydrochloric acid to react with each other, the trialkylchlorosilane 123 and the dialkyldichlorosilane 124 are produced, while water is produced as a by-product. For the chain siloxane, the compound shown in FIG. 5 is preferably used.

For example, in a case in which n=1, and R₁ to R₄ are methyl groups, the chain siloxane refers to octamethyltrisiloxane, and two molecules of trialkylchlorosilane 123 and one molecule of dialkyldichlorosilane 124 will be produced as active species.

For the chain siloxane, octamethyltrisiloxane, decamethyltetrasiloxane, dodecamethylpentasiloxane, etc. may be employed.

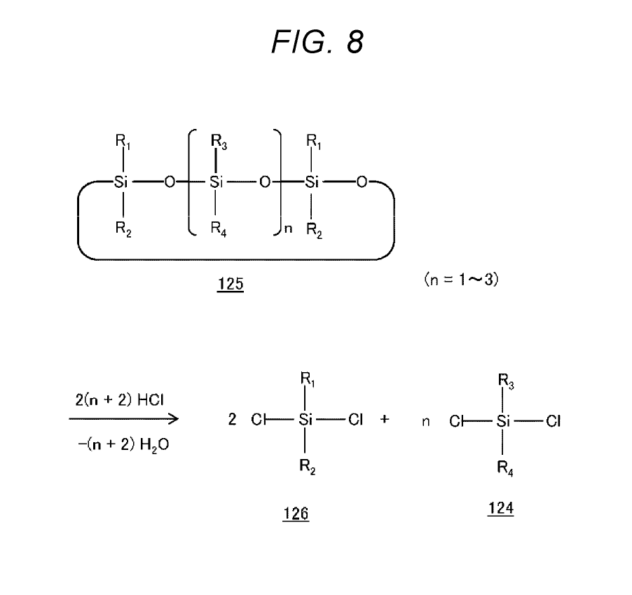

FIG. 8 shows that a dialkyldichlorosilane 126 and a dialkyldichlorosilane 124 are produced through a reaction between a cyclosiloxane 125 and hydrochloric acid.

By causing the cyclosiloxane 125 and hydrochloric acid to react with each other, the dialkyldichlorosilane 126 and the dialkyldichlorosilane 124 are produced, while water is produced as a by-product. For the cyclosiloxane, hexamethylcyclotrisiloxane, octamethylcyclotetrasiloxane, decamethylcyclopentasiloxane, etc. may be employed.

Among the above compounds, hexamethylcyclotrisiloxane is solid at room temperature. Therefore, when this compound is used as a hydrophobization agent in the disclosure, the reaction is carried out in a state in which the compound is heated to 70° C. so as to be melted. A melting point of hexamethylcyclotrisiloxane is from 64° C. to 66° C., and therefore, there would be no problem as long as it is heated to a temperature higher than the melting point. However, it may be required that it is heated to about 70° C. or higher, in order to reduce the viscosity, thereby quickly causing the reaction to proceed.

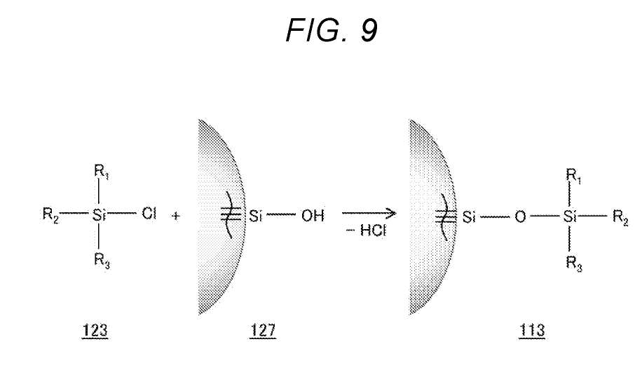

FIG. 9 refers to an example of a conventional art. In the conventional art, trialkylchlorosilane 123 serving as an active species, and a silanol group 127 present on surfaces of silica particles react with each other to form a trialkylsiloxane bond 113, which is a hydrophobic group.

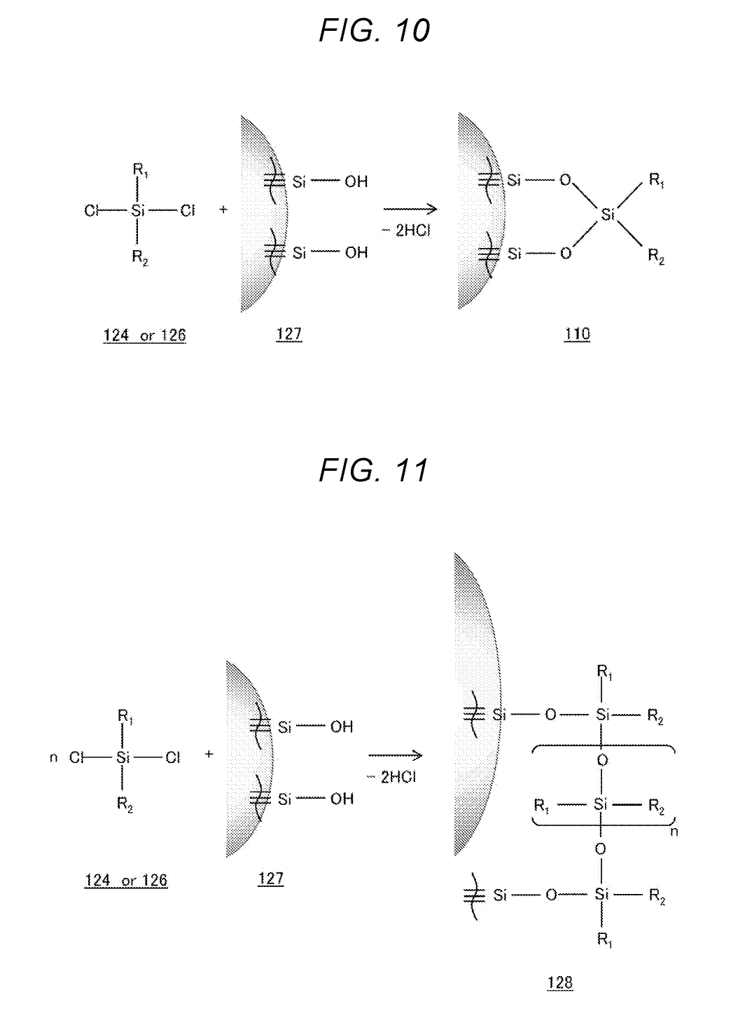

FIGS. 10 and 11 refer to an embodiment. In FIG. 10 a dialkyldichlorosilane 124 or a dialkyldichlorosilane 126 serving as an active species is caused to react with a silanol group 127 present on a surface of silica particles to form a dialkyldisiloxane bond 110. In FIG. 11, dialkyldichlorosilane 124 or a dialkyldichlorosilane 126 serving as an active species is caused to react with a silanol group 127 present on surfaces of silica particles to form a crosslinked disiloxane bond 128.

In the case of FIG. 7, when n=1, a ratio of the number of molecules of the trialkylchlorosilane 123 to the number of molecules of the dialkyldichlorosilane 124 is 2:1. As a result, through the reactions shown in FIG. 9 and FIG. 10, a ratio of a production of the trialkylsiloxane bond 113 and a production of the dialkyldisiloxane bond 110 will be 2:1.

In the same manner, when n=2, a ratio of the number of molecules of the trialkylchlorosilane 123 to the number of molecules of the dialkyldichlorosilane 124 is 2:2. As a result, through the reactions shown in FIG. 9 and FIG. 10, a ratio of a production of the trialkylsiloxane bond 113 and a production of the dialkyldisiloxane bond 110 will be 2:2.

In the same manner, when n=3, a ratio of the number of molecules of the trialkylchlorosilane 123 to the number of molecules of the dialkyldichlorosilane 124 is 2:3. As a result, through the reactions shown in FIG. 9 and FIG. 10, a ratio of a production of the trialkylsiloxane bond 113 and a production of the dialkyldisiloxane bond 110 will be 2:3.

Thus, the number of molecules of the produced dialkyldisiloxane bonds 110 would be about 0.5 to about 1.5 times greater than the number of molecules of the produced trialkylsiloxane bond 113.

In a case in which either the chain siloxane 122 (FIG. 7) or the cyclosiloxane 125 (FIG. 8) is used as a hydrophobization agent, by way of soaking the hydrogel in hydrochloric acid in advance in the above-mentioned first hydrophobization step, the reaction shown in FIG. 7 or 8 will efficiently proceed inside the gel.

An amount of the chain siloxane 122 or the cyclosiloxane 125 serving as a hydrophobization agent is preferably from about 100% to about 800%, more preferably from about 100 to about 300%, relative to a pore volume of the hydrogel.

The amount of the hydrophobization agent is determined on the basis of the pore volume of the hydrogel. For example, if the amount of the hydrophobization agent is 150% relative to the pore volume of the hydrogel, this means that 1.5 times the amount of the hydrophobization agent to the pore volume of the hydrogel is added to the reaction.

The pore volume of the hydrogel corresponds to a value that is obtained by subtracting a volume per unit weight of SiO₂ from a volume per unit weight of the starting material aqueous solution, and can be calculated based on the following formulas 1 to 3.

Volume of pores of the hydrogel (equivalent to a volume of water present inside the gel)=Volume of the starting material aqueous solution−Volume of SiO₂ (Formula 1)

Volume of the starting material aqueous solution=Weight of the starting material aqueous solution (g)÷Density of the starting material aqueous solution (cm³/g) (Formula 2)

Volume of SiO₂=(Weight of the high-molar-ratio silicate aqueous solution (g)×Silicate concentration)÷Density of SiO₂ (2.2) (cm³/g) (Formula 3)

If the amount of the hydrophobization agent is smaller than 100%, silanols (Si—OH) present on the surface of and inside the hydrogel may be unreacted, and thus, may remain therein. In that case, the silanols may be brought into physical contact with each other due to capillary force generated during the drying step, and thus, dehydration-condensation reactions may occur. This leads to shrinkage/high densification of the gel.

If the amount of the hydrophobization agent is larger than 800% relative to the pore volume of the hydrogel, then, the amount may be excess with respect to a minimum of the hydrophobization agent that is subjected to the reaction with silanols. In that case, the economic efficiencies and the productivity may be impaired.

If necessary, the hydrophobization reaction may be carried out in a solvent. The hydrophobization reaction is carried out generally at about 20° C. to about 100° C., preferably at about 40° C. to about 80° C.

If the reaction temperature is lower than 20° C., then, the hydrophobization agent may not sufficiently be diffused, and therefore, hydrophobization may not sufficiently be progressed.

If the reaction temperature exceeds 100° C., then, the hydrophobization agent may easily be vaporized, and the silylating agent that is required for progress of the reaction may not be supplied to the interior and the exterior of the hydrogel. At the same time, there maybe a safety problem since the aqueous acid that is discharged from the gel with the progress of the hydrophobization reaction may come to a boil.

As long as the reaction temperature is within a range from about 40° C. to about 80° C., the hydrophobization agent is quickly diffused therein. Therefore, the reaction will sufficiently progress. Furthermore, since the aqueous acid that is discharged from the gel with the progress of the hydrophobization reaction will not come to a boil, the reaction can safely be handled.

For the solvent, alcohols (e.g., methanol, ethanol, 2-propanol, 1-butanol, and 2-butanol), ketones (e.g., acetone and methylethylketone), linear aliphatic hydrocarbons (e.g., pentane, hexane, and heptane), etc. can preferably be used.

While the hydrogel is solid and hydrophilic, the hydrophobization agent is liquid and hydrophobic. Therefore, these materials are not mixed with each other. Because of the solid-liquid heterogeneous system reaction, alcohols or ketones, which are amphiphilic solvents, are preferably employed in order to cause reaction active species to react with the hydrogel.

### <Drying Step 121>

In the drying step, the liquid solvent present inside the hydrophobized gel 120 obtained in the previous step is vaporized. For a drying technique used herein, any known drying methods may be employed, and there are no limitations thereto. For example, supercritical drying methods, and non-supercritical drying methods (ordinary-pressure drying methods, and freeze-drying methods) can be employed therefore.

With regard to non-supercritical drying methods, ordinary-pressure drying methods may preferably be employed in terms of safeness and economic efficiencies. The drying temperature and the drying time are not particularly limited. However, if the hydrogel is rapidly heated, bumping of the solvent inside the hydrogel maybe caused, and thus, large cracks may be caused inside the silica aerogel. If cracks are caused inside the silica aerogel, heat-insulation properties may be impaired because of heat transmission due to convection of the air therein, and ease of handling the aerogel may significantly be impaired since it may become pulverulent.

In the drying step, for example, the gel may preferably be dried under ordinary pressure at about 0° C. to about 400° C. (drying temperature) for about 0.5 to about 5 hours.

If the drying temperature is lower than 0° C., then, the time required for the drying step may be longer, and the productivity may be impaired.

Furthermore, if the drying temperature is higher than 400° C., the dialkyldisiloxane bond 110 or the crosslinked disiloxane bond 128 in the hydrophobic aerogel may be released due to thermal decomposition, although it depends on hydrophobization conditions. This may lead to production of a hydrogel having no hydrophobicity. In addition, in cases where hydrophobic aerogels are produced by impregnating the sol solution into substrates such as resin unwoven fabrics or fibers, they are preferably dried at about 200° C. or lower, i.e., preferably dried at a temperature equal to or lower than boiling points of the substrates.

The hydrophobic aerogel obtained in the above manner in this embodiment has excellent thermostability, only very slight amounts of low-molecular siloxanes, which causes defects inside electronic devices, would be produced therein. Therefore, the hydrophobic aerogel serves as an excellent heat-insulation material, sound-absorbing material, water-repellant material, adsorption material, and the like. Furthermore, since the hydrophobization agent used in present embodiments has a higher boiling point, and therefore, will not be hydrolyzed through reactions with water in the atmosphere, it can be employed on an industrial scale.

### EXAMPLES

Hereinafter, the disclosure will further be described with reference to an example. However, the disclosure is not limited to the example described below. All of reactions described below were carried out under the atmospheric air.

An amount of a low-molecular siloxane present in the resulting aerogel was analyzed based on automatic thermal desorption-gas chromatography-mass spectrometry (ATD-GCMS).

For the analyzer, TurboMatrix ATD/Clarus SQ 8T/Clarus 680 (PerkinElmer) was employed, while SPB-5 (60 m×0.25 mm×0.25 um) was used as a column. Sample-heating conditions were 150° C. for 10 minutes, and injection amounts were 14.3%. Column-temperature-raising conditions were as follows. That is, the column was heated to 100° C. at 10° C./minute, and then, was heated to 290° C. at 20° C./minute. Then, measurements were carried out while the column was maintained at 290° C. for 19 minutes.

### Example 1

0.07 g of hydrochloric acid (serving as an acid catalyst) (KANTO KAGAKU) (Cica special grade; 12 N) was added to 5.00 g of water glass (TOSO SANGYO Co., Ltd.) (SiO₂ concentration: 14 wt %). The resulting mixture was stirred so as to be homogeneous, and the pH of the sol solution was adjusted to 7.2.

It took about 15 minutes until the sol solution was gelatinized at room temperature, and the resulting gel was aged inside a furnace at 80° C. for 3 hours. The hydrogel obtained in this way was soaked in 50 g of hydrochloric acid (KANTO KAGAKU) (Cica special grade; 12 N) at room temperature for 30 minutes. Then, 750% (32.3 mL; 27.1 g; 115 mmol) of octamethyltrisiloxane relative to 4.3 mL of a pore volume of the hydrogel, and one equivalent (molar ratio) (115 mmol) of 2-propanol relative to the amount of octamethyltrisiloxane were added to the solution, and the hydrogel was hydrophobized in the furnace at 55° C. for 2 hours. In addition, the octamethyltrisiloxane was KF-96L-1cs supplied from Shin-Etsu Chemical Co., Ltd., which is a chain siloxane (MW=236.534; bp=153° C.; and d=0.84 g/ml (25° C.)).

After the reaction, the reaction solution was separated into two phases (octamethyltrisiloxane in the upper layer, and aqueous HCl in the lower layer). Then, the gel was harvested therefrom, and was dried in the air at 150° C. for 2 hours. Thus, 0.65 g of a colorless and transparent silica aerogel was obtained.

The resulting hydrophobic aerogel was subjected to the ATD-GC/MS analysis. As a result, an amount of trimethylsilanol was 0.80 μg/g, and an amount of hexamethyldisiloxane was 0.01 μg/g. An amount of octamethyltrisiloxane was smaller than 0.34 μg/g. A total amount of low-molecular siloxanes detected in the analysis was 1.14 μg/g, and thus, was very small.

### Comparative Example 1

0.08 g of hydrochloric acid (serving as an acid catalyst) (KANTO KAGAKU) (Cica special grade; 12 N) was added to 5.02 g of water glass (TOSO SANGYO Co., Ltd.) (SiO₂ concentration: 14 wt %). The resulting mixture was stirred so as to be homogeneous, and the pH of the sol solution was adjusted to 7.3.

It took about 15 minutes until the sol solution was gelatinized at room temperature. The resulting gel was aged inside a furnace at 80° C. for 3 hours. The hydrogel obtained in this way was soaked in 50 g of hydrochloric acid (KANTO KAGAKU) (Cica special grade; 12 N) at room temperature for 30 minutes. Then, 750% (31.5 mL; 24.1 g; 148 mmol) of hexamethyldisiloxane (HMDSO) relative to 4.2 mL of a pore volume of the hydrogel, and one equivalent (molar ratio) (148 mmol) of 2-propanol relative to the amount of HMDSO were added to the solution. The HMDSO was KF-96L-0.65cs (MW=162.38; bp=101° C.; and d=0.764 g/mL at 20° C.) supplied from Shin-Etsu Chemical Co., Ltd. Then, the hydrogel was hydrophobized in the furnace at 55° C. for 2 hours. After the reaction, the reaction solution had been separated into two phases (HMDSO in the upper layer, and aqueous HCl in the lower layer). Then, the gel was removed therefrom, and was dried in the air at 150° C. for 2 hours. Thus, 0.65 g of a colorless and transparent silica aerogel was obtained.

The resulting hydrophobic aerogel was subjected to the ATD-GC/MS analysis. As a result, an amount of trimethylsilanol was 674.0 μg/g, and an amount of hexamethyldisiloxane was 185.2 μg/g. An amount of octamethyltrisiloxane was smaller than 0.01 μg/g. A total amount of low-molecular siloxanes detected in the analysis was 859 μg/g, and thus, was very large.

### <Results>

As described above, it was revealed that an amount of trimethylsilanol produced in the aerogel 111a obtained in EXAMPLE 1 was lower compared with the aerogel 111b synthesized in COMPARATIVE EXAMPLE 1, and the aerogel 111a had improved thermostability. Furthermore, since hydrophobization agents used in present embodiments have higher boiling points, and will not be hydrolyzed through reactions with water in the atmosphere, it becomes possible to produce the aerogels on an industrial scale. Aerogels according to the disclosure can be employed as excellent heat-insulation materials, sound-absorbing materials, water-repellant materials, adsorption materials, and the like.

Thus, aerogels according to the disclosure have excellent thermostability, and therefore, serve as excellent heat-insulation materials, sound-absorbing materials, water-repellant materials, adsorption material, and the like. The aerogels can be applied to various categories of produces that are associated with heat and/or sounds (e.g., electronic devices, industrial equipment, in-vehicle devices, heating/cooling systems, and building materials).

1. An aerogel comprising:
a first aerogel having, on a surface of the first aerogel, at least one type of dialkyldisiloxane bond serving as a hydrophobic group; and
a second aerogel having on a surface of the second aerogel one type of trialkylsiloxane bond.

2. The aerogel according to claim 1, wherein the alkyl groups present in the one type of dialkyldisiloxane bond each have a carbon number from 1 to 10.

3. An aerogel, according to claim 1,
wherein the number of molecules of the first aerogel is about 0.5 to about 1.5 times greater than the number of molecules of the second aerogel.

4. The aerogel according to claim 1, wherein the alkyl groups present in the at least one type of trialkylsiloxane bond each have a carbon number from 1 to 10.

5. (canceled)

6. An aerogel, comprising:
an third aerogel having, on a surface of said third aerogel, at least one type of dialkyldisiloxane bond serving as a hydrophobic group, and/or at least one type of crosslinked disiloxane bond serving as a hydrophobic group; and
a fourth aerogel having on a surface of said fourth aerogel at least one type of trialkylsiloxane serving as a hydrophobic group, wherein the number of molecules of the third aerogel is about 0.5 to about 1.5 times greater than the number of molecules of the fourth aerogel.

7. The aerogel according to claim 6, wherein the alkyl groups present in the at least one type of trialkylsiloxane bond each have a carbon number from 1 to 10.

8. The aerogel according claim 1, having a mean pore diameter from about 10 nm to about 60 nm, a pore volume from about 3.0 cc/g to about 10 cc/g, and a specific surface area from about 200 m²/g to about 1200 m²/g.

9. A material serving as at least one material selected from among a heat-insulation material, a sound-absorbing material, a water-repellant material, and an adsorption material, said material comprising the aerogel according to claim 1.

10. A method for producing an aerogel, comprising:
(i) providing a silica hydrogel;
(ii) hydrophobizing the silica hydrogel by using at least one siloxane selected from among a chain siloxane represented by Formula (1), and a cyclosiloxane represented by Formula (2), 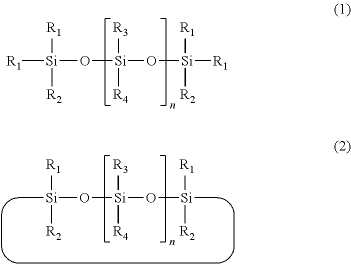
wherein 1≤n≤3, and R₁ to R₄ independently represent C1-C10 aliphatic hydrocarbon groups.

11. The method according to claim 10, wherein, in step (ii), the silica hydrogel is soaked in 3-12 N hydrochloric acid to cause said hydrochloric acid to penetrate into the silica hydrogel, and the silica hydrogel is hydrophobized in a mixture solvent of an alcohol and the at least one siloxane.
